(19) United States
(12) Patent Application Publication
(10) Pub. No.: US 2012/0189811 A1
(43) Pub. Date: Jul. 26, 2012

(54) COPPER ELECTROLYTIC SOLUTION AND TWO-LAYER FLEXIBLE SUBSTRATE OBTAINED USING THE SAME

(75) Inventor: Mikio HANAFUSA, Hitachi-shi (JP)

(73) Assignee: Nippon Mining & Metals Co., Ltd.

(21) Appl. No.: 13/437,372

(22) Filed: Apr. 2, 2012

Related U.S. Application Data
(62) Division of application No. 12/450,054, filed on Sep. 8, 2009.

(30) Foreign Application Priority Data
Mar. 15, 2007 (JP) 2007-066382

(51) Int. Cl. B32B 3/00; C22C 9/00

(52) U.S. Cl. 428/141; 420/469

(57) ABSTRACT

A copper electrolytic solution containing chloride ions, a sulfur organic compound and polyethylene glycol as additives, and the copper electrolytic solution preferably contains 5 to 200 ppm of chloride ions, 2 to 1000 ppm of a sulfur organic compound and 5 to 1500 ppm of polyethylene glycol. A two-layer flexible substrate having a copper layer is formed using the copper electrolytic solution, wherein the MIT folding endurance is 100 or more, and the surface roughness (Rz) of the copper layer is 1.4 to 3.0 μm.

### CROSS-REFERENCE TO RELATED APPLICATIONS

This is a division of prior U.S. application Ser. No. 12/450 054, filed Sep. 8, 2009, which was the national stage of International Application No. PCT/JP2008/053987, filed Mar. 5, 2008.

### BACKGROUND OF THE INVENTION

1. Field of the Invention

The present invention relates to a copper electrolytic solution and a two-layer flexible substrate obtained using the solution, and more specifically relates to a two-layer flexible substrate comprising a copper layer formed on an insulator film.

2. Description of the Related Art

Two-layer flexible substrates are attracting attention as substrates for use in preparing flexible wiring boards. The advantage of a two-layer flexible substrate, in which a copper conductor layer is provided directly on an insulator film without the use of an adhesive, is that not only can the substrate itself be thinner, but the copper conductor layers to be deposited can also be adjusted to any desired thickness. Such a two-layer flexible substrate is normally manufactured by first forming an underlying metal layer on the insulator film, and then applying copper electroplating. However, many pinholes occur in an underlying metal layer obtained in this way, exposing parts of the insulator film, and when the copper conductor layer is thin it may not cover the areas exposed by the pinholes, resulting in pinholes in the surface of the copper conductor layer as well, which have been a cause of wiring defects. One method of solving this problem is that described in Japanese Patent Publication No. H10-193505, whereby an underlying metal layer is prepared by dry plating on an insulator film, and a primary copper electroplate film is formed on the underlying metal layer and then subjected to alkali solution treatment, after which an electroless copper plating layer is deposited and finally a secondary copper electroplate layer is formed to produce a two-layer flexible substrate. However, this method involves complex processes.

Due to the recent trend toward higher-density printed wiring boards, moreover, there is demand for copper layers that allow for smaller circuit widths and fine patterning in multiple layers. Two-layer flexible substrates are often folded during use, so the copper layer needs to have excellent folding endurance.

Moreover, if a resist is applied to the copper plate followed by further plating to create wiring, the resist may peel in some cases because the copper surface is highly glossy, so there is demand for two-layer flexible substrates having excellent adhesiveness with resist.

### SUMMARY OF THE INVENTION

It is an object of the present invention to provide a two-layer flexible substrate having excellent MIT properties (folding endurance), resist adhesiveness with no surface defects.

That is, the present invention consists of the following.
(1) A copper electrolytic solution containing chloride ions, a sulfur organic compound and polyethylene glycol as additives.
(2) The copper electrolytic solution according to (1) above, containing 5 to 200 ppm of chloride ions, 2 to 1000 ppm of a sulfur organic compound and 5 to 1500 ppm of polyethylene glycol.
(3) A two-layer flexible substrate having a copper layer provided on one or both sides of an insulator film without the use of an adhesive, wherein the copper layer is formed using a copper electrolytic solution according to (1) or (2) above, the MIT folding endurance is 100 or more, and the surface roughness (Rz) of the copper layer is 1.4 to 3.0 μm.
(4) The two-layer flexible substrate according to (3) above, wherein the insulator film is a polyimide film.

A two-layer flexible substrate prepared using the copper electrolytic solution of the present invention can have a MIT folding endurance of 100 or more and a surface roughness (Rz) of the copper layer of 1.4 to 3.0 (μm, and has excellent resist adhesiveness.

Moreover, within this range of surface roughness fine line formation is not affected, surface defects are eliminated and yield is improved.

### DETAILED DESCRIPTION OF THE PREFERRED EMBODIMENTS

In the two-layer flexible substrate of the present invention which comprises a copper layer formed on an insulator film using the copper electrolytic solution of the present invention, it is preferable to first form an underlying metal layer on the insulator film, then form a copper layer of a specific thickness by electroplating.

The insulator film used in the present invention may be a film consisting of 1 or a mixture of 2 or more of polyimide resin, polyester resin, phenol resin and other thermosetting resins, polyethylene resin and other thermoplastic resins, polyamide and other condensed polymers and other resins. Polyimide film, polyester film or the like is preferred, and polyimide film is especially desirable. Examples of polyimide films include various polyimide films such as Kapton (Toray duPont), Uplex (Ube Industries) and the like.

The insulator film is preferably 10 to 50 μm thick.

An underlying metal layer of a single element such as Ni, Cr, Co, Ti, Cu, Mo, Si, V or the like or a mixed system thereof can be formed on the insulator film by a known method such as vapor deposition, sputtering, plating or the like.

The underlying metal layer is preferably 10 to 500 nm thick.

The two-layer flexible substrate of the present invention has a copper plating layer formed using the copper electrolytic solution of the present invention on an insulator film that preferably has an underlying metal layer already formed thereon as discussed above.

Copper sulfate or a solution of metal copper dissolved in sulfuric acid or the like can be used as the copper ion source for the copper electrolytic solution. For the copper electrolytic solution, additives are added to an aqueous solution of the aforementioned compound as the copper ion source, or to a solution of metal copper dissolved in sulfuric acid.

By using a copper electrolytic solution of the present invention comprising chloride ions, polyethylene glycol and a sulfur organic compound mixed as additives with an aqueous solution containing a copper ion source such as a copper sulfate aqueous solution, it is possible to achieve a two-layer flexible substrate with a MIT folding endurance of 100 or more, a surface roughness (Rz) of the copper layer of 1.4 to 3.0 μm, and excellent adhesiveness with resist.

The aforementioned sulfur organic compound is preferably a compound having the structure of General Formula (1) or (2) below:

X—R¹—(S)ₙ—R²—Y (1)

R⁴—S—R³—SO₃Z (2)

(wherein General Formulae (1) and (2), R¹, R² and R³ are Cl-8 alkylene groups, R⁴ is selected from the group consisting of hydrogen and

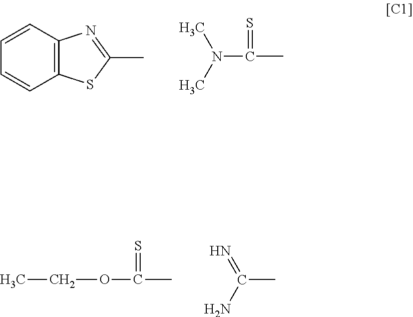

X is selected from the group consisting of hydrogen, sulfonic acid groups, phosphonic acid groups, and alkali metal salts or ammonium salts of sulfonic acid groups or phosphonic acid groups, Y is selected from the group consisting of sulfonic acid groups, phosphonic acid groups, and alkali metal salts of sulfonic acid groups or phosphonic acid groups, Z is hydrogen or an alkali metal, and n is 2 or 3).

The following are examples that can be used by preference as the sulfur organic compound represented by General Formula (1) above
H₂O₃P—(CH₂)₃—S—S—(CH₂)₃—PO₃H₂
HO₃S—(CH₂)₄—S—S—(CH₂)₄—SO₃H
HO₃S—(CH₂)₃—S—S—(CH₂)₃—SO₃H
NaO₃S—(CH₂)₃—S—S—(CH₂)₃—SO₃Na
HO₃S—(CH₂)₂—S—S—(CH₂)₂—SO₃H
CH₃—S—S—CH₂—SO₃H
NaO₃S—(CH₂)₃—S—S—S—(CH₂)₃—SO₃Na
(CH₃)₂CH—S—S—(CH₂)₂—SO₃H

The following are examples that can be used by preference as the sulfur organic compound represented by General Formula (2) above.

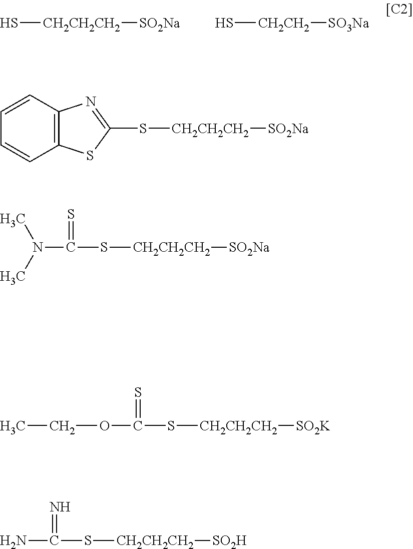

The polyethylene glycol preferably has a weight-average molecular weight of 600 to 30000.

The chloride ions in the copper electrolytic solution can be included for example by dissolving a compound containing NaCl, MgCl₂, HCl or other chloride ions in the electrolytic solution.

The copper electrolytic solution of the present invention preferably contains 5 to 200 ppm of chloride ions, 2 to 1000 ppm of a sulfur organic compound and 5 to 1500 ppm of polyethylene glycol. The content of chloride ions is more preferably 10 to 100 ppm, and still more preferably 30 to 80 ppm. The content of the sulfur organic compound is more preferably 5 to 500 ppm and still more preferably 10 to 50 ppm. The content of polyethylene glycol is more preferably 10 to 1000 ppm and still more preferably 20 to 200 ppm.

If there is an excess of chloride ions the copper layer will tend to have the properties of ordinary copper foil having rough surface. If there is an excess of the sulfur organic compound, the surface condition will be poor, and more round pinholes in particular will occur due to adhesion of bubbles. If there is an excess of polyethylene glycol, the plate surface will not be affected, but bubbling of the electrolyte will be severe, and the costs will be higher.

By including all three additives it is possible to obtain the desired properties, and in particular to keep the surface roughness within the desired range. It is thought that including all three additives produces a larger, more granular crystal structure, resulting in fewer grain boundaries and improved MIT properties. When no sulfur organic compound or polyethylene glycol is included the chloride ions have a greater effect, resulting in an rough surface (generally similar to that of ordinary copper foil). In this case the MIT properties are also poor. It is thought that this occurs because the crystals are columnar crystals with crystal boundaries perpendicular to the copper layer, and cracks occur along these boundaries when the substrate is folded. When there no chloride ions are included, on the other hand, the surface roughness is less but not as low as desired. The crystals are also very small, detracting from the MIT properties.

The two-layer flexible substrate of the present invention has a copper layer formed by electroplating using the aforementioned copper electrolytic solution on a substrate having an underlying metal layer. Plating is performed at a bath temperature of preferably 30 to 55° C. or more preferably 35 to 45° C. The thickness of the formed copper layer is preferably 3 to 30 μm.

The surface roughness (Rz) of the copper layer should be 1.4 to 3.0 μm or preferably 1.9 to 3.0 μm. The surface roughness (Rz) of the copper layer of an ordinary two-layer flexible substrate is about 0.3 to 1.0 μm. The aforementioned range is achieved in the present invention by using three kinds of additives in the copper electrolytic solution.

The surface roughness of the copper layer can be measured with a non-contact type surface roughness meter (Veeco). If the surface roughness (Rz) is too low adhesiveness with the etching resist will be poor, and peeling may occur during etching. If the surface is rough adhesiveness with the etching resist will be good, but diffuse reflection from the rough surface will occur when the resist is exposed, with the result that resist at the points of contact between the copper plate and resist remains, making accurate fine pattern etching impossible. This is why the surface roughness (Rz) is preferably 1.4 to 3.0 μm or more preferably 1.9 to 3.0 μm.

The surface roughness (Ra) is preferably 0.18 to 0.28 and the surface roughness (Rt) is preferably 2.3 to 3.5.

A two-layer flexible substrate prepared using the copper electrolytic solution of the present invention has excellent MIT properties, with folding endurance (measured under 500 g weight, R=0.38 based on JISC 5016) of 100 or more. The MIT folding endurance of 120 or more is preferred.

### EXAMPLES

The present invention is explained next with examples, but the present invention is not limited by these examples.

### Examples 1 to 13, Comparative Examples 1 to 3

The additives were added to aqueous solutions adjusted to the following concentrations with copper sulfate and sulfuric acid, and a polyimide film with an underlying metal layer was electroplated under the following plating conditions to prepare copper plate about 8 μm thick. The plating temperature was 40° C., and the additives and their added amounts were as shown in Table 1. In Table 1, the added amounts of the additives are given as ppm. Hydrochloric acid was used as the chloride ion source.
Liquid volume: 1700 ml
Anode: Lead electrode
Cathode: Rotating electrode wrapped in polyimide film
Polyimide film with underlying metal layer: 37.5 μm Kapton E (Dupont) sputtered with 150 Å Ni—Cr followed by 2000 Å copper
Current time: 2800 As
Current density: 5→15→25→40 A/dm²,
   each maintained for 35 seconds
Cathode rotation speed: 90 rpm
Copper ions: 70 g/L
Free sulfuric acid: 60 g/L

The surface roughness (Rz), (Ra), and (Rt) of the resulting copper-plated polyimide two-layer substrate was measured based on JIS B0601 using a non-contact surface roughness meter (Veeco), and a folding endurance test was performed under 500 g weight, R=0.38 based on JIS C5016. Etching resist was evaluated by exposing and developing lines with a line/space L/S of 20/20 (20 μm pitch), and observing remaining resist by scanning electron microscopy (SEM).

The results are given in Table 1.

TABLE 1

| | | | | | | | | | Folding | |
|---|---|---|---|---|---|---|---|---|---|---|
| | Chloride | | | | | | | | endurance | Resist |
| | ions | Additive 1 | Additive 2 | Additive 3 | PEG | Ra | Rt | Rz | (times) | remaining |
| Ex1 | 10 | 5 | | | 10 | 0.25 | 3.47 | 2.99 | 141 | No |
| Ex2 | 60 | 5 | | | 50 | 0.18 | 2.34 | 1.91 | 163 | No |
| Ex3 | 100 | 5 | | | 1000 | 0.20 | 2.36 | 2.07 | 139 | No |
| Ex4 | 10 | 20 | | | 10 | 0.22 | 3.02 | 2.57 | 162 | No |
| Ex5 | 60 | 20 | | | 50 | 0.18 | 2.97 | 1.58 | 172 | No |
| Ex6 | 100 | 20 | | | 1000 | 0.19 | 2.91 | 1.40 | 165 | No |
| Ex7 | 10 | 500 | | | 10 | 0.27 | 3.22 | 2.68 | 190 | No |
| Ex8 | 60 | 500 | | | 50 | 0.25 | 2.74 | 2.27 | 198 | No |
| Ex9 | 100 | 500 | | | 1000 | 0.25 | 2.71 | 2.32 | 121 | No |
| Ex10 | 60 | | 5 | | 50 | 0.26 | 3.22 | 2.83 | 180 | No |
| Ex11 | 60 | | 500 | | 50 | 0.25 | 3.08 | 2.91 | 131 | No |
| Ex12 | 60 | | | 5 | 50 | 0.25 | 3.29 | 2.86 | 145 | No |
| Ex13 | 60 | | | 500 | 50 | 0.24 | 3.06 | 2.65 | 157 | No |
| CE1 | 0 | 20 | | | 50 | 0.17 | 2.49 | 3.70 | 53 | No |
| CE2 | 60 | 20 | | | | 0.19 | 5.42 | 4.20 | 122 | Yes |
| CE3 | 60 | | | | 50 | 0.98 | 6.21 | 5.43 | 78 | Yes |
| CE4 | 60 | | | | | 0.19 | 5.42 | 4.20 | 36 | Yes |

Additive 1: Bis-(3-sulfopropyl)-disulfide sodium salt
Additive 2: 3-mercapto-l-propanesulfonic acid sodium salt
Additive 3: 2-mercaptoethane sulfonic acid sodium salt
PEG: Polyethylene glycol, weight-average molecular weight 6000

These results show that the copper polyimide two-layer substrate of the present invention has excellent folding endurance and adhesiveness with resist, with no surface defects.

What is claimed is:

1. A two-layer flexible substrate having a copper layer provided on at least one side of an insulator film without the use of an adhesive and having a MIT folding endurance of at least 100, the copper layer having a surface roughness, Rz, of 1.4 to 3.0 μm and being formed by the use of a copper electrolic solution containing copper, chloride ions, a sulfur organic compound and polyethylene glycol.

2. The two-layer flexible substrate according to claim 1, wherein the insulator film is a polyamide film.

3. A copper film which is formed at a current density of at least 25 A/dm² using a copper electrolytic solution containing copper, chloride ions, a sulfur organic compound and polyethylene glycol.
